(19) United States
(12) Patent Application Publication
(10) Pub. No.: US 2021/0271348 A1
(43) Pub. Date: Sep. 2, 2021

(54) SYSTEM FOR AN ERGONOMIC INTERACTION OF A USER WITH DATA

(71) Applicant: HALLO WELT SYSTEME UG (HAFTUNGSBESCHRAENKT), Remscheid (DE)

(72) Inventor: Joerg WURZER, Remscheid (DE)

(21) Appl. No.: 17/258,628

(22) PCT Filed: Jul. 2, 2018
(86) PCT No.: PCT/EP2018/067827

§ 371 Date: Jan. 7, 2021

(51) Int. Cl. G06F 3/0481

(52) U.S. Cl. CPC G06F 3/0481; G06N 20/00

(57) ABSTRACT

A data processing system for ergonomic interaction of a user with data, comprising: at least one processor unit, at least one local and/or network accessible data store containing data, local and/or network accessible content representing data objects, a list of semantic content classes of data objects and the technical criteria of content classes, a list of/containing functions available on the system for an interaction with data and the technical conditions of the functions, and a human-machine interface for providing information and/or controls with respect to a user's interaction with data, with means for providing, preferably continuously instantaneous, situationally appropriate functions for a user's interaction with data by means of the man-machine interface with at least two options for action for the user, a first option with regard to a creation of preferably persistent and/or transient content and a second option with regard to a call to data and/or apps representing content, where the first option is determined or can be determined using the list of functions available on the system for a human-machine interaction with data and the technical conditions of the functions and the second option is determined or determinable using the list of semantic content classes of the data objects and the technical criteria of the content classes and/or using the list of/containing system-side available functions for a human-machine interaction with data and the technical conditions of the functions.

### FIELD

The present invention relates to a system for ergonomic interaction of a user with data.

The system or data processing system comprises at least one processing unit, at least one local and/or network accessible data store, local and/or network accessible content representing data objects, and a man-machine interface for providing information and/or control elements with respect to a user's interaction with data.

### BACKGROUND

In the prior art, the purpose of a human-machine interface used in stationary and mobile computer systems is to allow users to capture, display, edit, share, store, delete, and retrieve digital content. For this purpose, operating systems of stationary and mobile computer systems use files and directories for storage and programs for editing them. Each program has its own defined functions that can be accessed via a program menu.

Human-machine interfaces of today's operating systems are particularly characterized by technology. Even in modern mobile operating systems, the functionality of so-called apps is subordinated to a technical paradigm.

Today's data and information processing systems are characterized by a large number of executable programs (apps), menu structures, hierarchical and distributed file locations, and services available over a network. Operating systems for mobile devices have abstracted file locations, but have subsequently reintroduced them due to a lack of alternative concepts, especially Apple's iOS. For the user, this multiplicity means a high and even increasing confusion, if that multiplicity increases. This is especially true for programs that can be used on the move as well as services (especially so-called cloud services) that are available via the network. In addition to the lack of clarity, this means for the user a constant change between programs, storage locations and services, between which a system even usually cannot establish a relationship and/or exchange data. An integral, cross-system concept for a user interface and user guidance is missing.

One of the core functions of data and information processing systems is in particular the retrieval of data and/or information as well as the output of data and/or information. Here, current operating systems offer the aforementioned multitude of programs, hierarchical and distributed file locations or file storage locations, and the concept of a search, usually in the form of a free-text search. For those core functions, the user often has to select the appropriate apps, switch between them, descend into the hierarchy of file storage locations, switch between storage locations, or select suitable terms for a search, which are usually even distributed across various local services and those available over a network, so that a selection or sequential query is necessary. Last but not least, search results have to be sifted and selected because usually one keyword or two keywords are not enough to get the desired data or information.

The need for the core functions of data and information processing systems, the input, processing, retrieval, output, and sharing or distribution of data representing information, are served by not only a variety of technical structures of a single data processing system, but a variety of data processing systems, according to the current state of the art. The number has also increased here. In addition to stationary systems (in particular so-called desktop computers), mobile systems in various sizes ranging from mobile (in particular so-called laptops) to lightweight (in particular so-called tablets) to handy (in particular so-called smart phones) and even portable devices (in particular so-called wearables) are in use, often operating just as independently and unconnectedly. Services available over a network, in particular so-called cloud services, are intended to close this gap, but in doing so they do not reduce the diversity of end devices and even increase the diversity for inputting, processing and/or retrieving data representing information.

Although the data and information processing systems known in the state of the art allow increasingly lighter, smaller and at the same time more powerful terminals, they also lead to an increasing ergonomic paradox. Even a mobile computer (especially a so-called laptop) with a keyboard and display connected by a joint leads to the incompatibility of a correct posture on the part of the user. Handheld devices (especially so-called smart phones), on the other hand, are hardly suitable for displaying long texts and certainly not for typing them. Here, too, an incompatibility with a healthy, correct posture on the part of the user is recognizable and given with permanent use. Finally, portable end devices (especially so-called wearables) such as watches (especially so-called smart watches) offer hardly any possibility to display data representing information or even to enter such data. As a result, many system manufacturers rely on natural language interaction with data-processing systems, overlooking the importance of written language and the ability to process and display information-representing data that cannot be conveyed via voice output. These systems, in turn, add to the diversity instead of providing an integral concept to reduce the diversity and complexity in favor of the actual needs of the users.

Last but not least, today's responses to the confusion, complexity and dominance of technical structures lead to dependencies on service providers with increasing monopolization, paternalism through conditioning on the limits of so-called artificial intelligence, and a loss of privacy and protection against surveillance and self-determination over personal and own data.

### SUMMARY

Accordingly, the motivation of the present invention is a data-processing system for simple, unmediated, ergonomic and self-determined handling of data representing information, which allows a user to focus on his intentions and activities, on content and people with whom he shares content. In this context, unmediated means direct interaction in which technical structures, especially their confusing diversity, recede into the background.

From the motivation, a technical problem arises, which is solved with the present invention. This technical problem can be described with the following interdependent or interacting, technical subproblems:

1. cross-system integral user guidance of a data processing system;
2. unmediated, direct provision of data, programs and/or functions;
3. unmediated, direct processing of data representing content;
4. overcoming system boundaries of internal and external system boundaries of a terminal device;
5. resolution of the ergonomic paradox and the previously associated need for multiple terminals;
6. resolve dependence of third-party systems on services available over the network, especially so-called cloud services.

For the technical solution, the present invention proposes a network of terminals with an adaptive system for the situational input, acquisition and/or output of data representing contents, which provides a system or data processing system for the ergonomic interaction of a user with data, in particular by means of distributed user guidance and data processing with networked user terminals, and is composed in particular of the following various subsystems which build on one another and/or complement one another, in particular subsystem S1, subsystem S2, subsystem S3, subsystem S4, subsystem S5 and/or subsystem S6:
Subsystem S1: Cross-system, integral man-machine interface (integral user guidance) for calling up data, programs and/or functions representing content; in particular with the following embodiments:
   Subsystem S1.1: Cross-system display of functions;
   Subsystem S1.2: Cross-system call of functions;
and/or
   Subsystem S1.3: Cross-system display of data representing content;
Subsystem S2: Cross-system, automatic and dynamic compilations of data, programs and/or functions representing content;
Subsystem S3: Cross-system, automatic and adaptive calculation, retrieval and/or provision of data, programs and/or functions representing situational content; in particular with the following embodiments:
   Subsystem S3.1: Automatic parameters of a situation of the user of a system as metadata;
   Subsystem S3.2: Automatic retrieval of data, programs and/or functions representing situational contents;
   Subsystem S3.3: Output of data, programs and/or functions representing situational contents;
and/or
   Subsystem S3.4: Automatic optimization of subsystem 3 using machine learning;
Subsystem S4: Adaptive user interface for the input and/or editing of data representing content; in particular with the following embodiments:
   Subsystem S4.1: Anticipation of the intention of a user of the entire system, in particular comprising subsystem S1, subsystem S2, subsystem S3, subsystem S4, subsystem S5 and/or subsystem S6;
and/or
   Subsystem S4.2: Adaptive human-machine interface;
Subsystem S5: Interconnection of terminal devices for the ergonomic, adaptive input and/or output of content-representing data; in particular with the following characteristics:
   Subsystem S5.1: Interconnection of terminals;
   Subsystem S5.2: Distribution of data;
and/or
   Subsystem S5.3: Distribution of arithmetic operations;
and/or
Subsystem S6: Interconnection of terminal devices for ergonomic virtual adaptive input and/or output of content representing data; in particular with the following embodiments:
   Subsystem S6.1: Virtual display;
and/or
   Subsystem S6.2: Mental control.

In the context of the present invention, the following terms are to be understood as follows:

Content: Contents in the sense of the present invention are data objects or a set (so-called set) of data objects representing a content unit, for example a message, a contact, a task, a document, an image.

Unmediated: Unmediated in the sense of the present invention means available at any time to the user for direct invocation, without a sequence of interactions by the user, for example changing programs, menu or directory hierarchies.

Situational: Situational in the sense of the present invention means related to a situation of the user, that is, in general, who, when, where is currently pursuing which intention, in particular, which activities the user of a system is performing in which situation on his terminal device.

Retrieval: Retrieval in the sense of the present invention is a system-based, automatic locating (finding) and selecting of data in the sense of information retrieval.

Invocation: Invocation in the sense of the present invention is a user-side request for data representing content.

Dynamic: Dynamic in the sense of the present invention is variable, depending on variable parameters or data.

Computation: Computation in the sense of the present invention is the machine processing (computation) of data, including the processing of character strings (strings) and complex data structures (dictionary, map, list, set, etc.) beyond simple data structures such as integer or floating point numbers (float).

The system according to the invention for ergonomic interaction of a user with data is explained in more detail below with reference to the various subsystems which build on one another and/or complement one another, in particular subsystem S1, subsystem S2, subsystem S3, subsystem S4, subsystem S5 and/or subsystem S6, as well as their respective embodiments:
1. subsystem S1: cross-system, integral man-machine interface (integral user guidance) for calling data, programs and/or functions representing content.

According to the invention, a system or data processing system is given which advantageously has the following features and/or properties:
Processor unit;
Data storage,
local or accessible via a network;
Data objects representing content,
local or accessible via a network,
locally or indexed via a network;
executable programs (apps),
local or accessible via a network,
locally or indexed via a network;
list of content classes and their technical criteria, where
   content classes are, for example, documents, photos, videos, but also programs (apps) and more complex classes such as unread messages (notifications), visited web pages or situational content,
technical criteria are, for example, file extensions, metadata such as the Internet Media Type (MIME Type), or storage locations, and the technical criteria may also be defined and/or applied in combination, including instructions for the calculation or retrieval of data, and/or
the content criteria are, for example, a specific addressee of messages, a motif or location of images, or a keyword for a document;
list of functions and their technical conditions, where

The functions include taking a photo, sending an email, or making an audio or video call,
the technical criteria are, for example, an available camera, a selected addressee or an existing mobile radio connection and wherein the technical criteria can also be defined or applied in combination, and/or
   the content criteria are, for example, the time, a day of the week, the location of the terminal or a specific calendar event;
and/or
Human-Machine Interface,
output of data and/or function options, and/or
Enter data and/or function calls.

This system or subsystem contributes in particular to solving the aforementioned technical problems 1. (Cross-system, integral user guidance of a data-processing system), 2. (Unmediated, direct provision of data, programs and/or functions) and 4. (Overcoming system boundaries of internal and external system boundaries of a terminal device).

Advantageously, the following embodiments are further provided according to the invention:

### 1.1 Subsystem S1.1: Cross-system Display of Functions

The human-machine interface of this system reflects the core functions of data or information processing systems mentioned at the beginning, namely input, processing, retrieval, output and/or distribution of data representing information, advantageously with the following features and/or characteristics:

1. The system offers dynamic options for action in terms of technical functions in at least two groups (so-called dual menu) at any time:

s1. options to capture or add content representing data, where the system derives the options from the available features and their technical and/or content conditions. The content representing data can be persistent (for example, photos, messages, notes) or transient (for example, audio and/or video call).

2. options to call content representing data, where
the system derives the options from the available content classes,
which includes options dynamic compilations of data representing content and/or executable programs (apps),
the system can call both the compilations and the programs with parameters, for example, an e-mail program with parameters for the date sent and the sender name, or a file manager with parameters for the file type and search term, or a web browser with a parameter for a URL.
   2. if the system displays a datum representing a content or if the user has selected such a datum, the system can offer a third group (so-called triple menu) of further options for action in terms of technical functions using that datum, in particular for sharing and/or linking and/or retrieving further data representing contents, whereby
the system derives the options for sharing from the available functions and the included or referenced communication channels,
the system derives the options for linking from the content classes and their technical criteria and/or the indexed content itself, where
the options for linking include the explicit selection of data representing content and/or the implicit selection of data representing content based on search queries,
the system persists the explicit and/or the parameters for the implicit connections in the data memory to use them for the unmediated retrieval of further data representing contents; and/or
the system derives the options for the call from the content classes and their technical criteria and/or conditions.

### 1.2 Subsystem S1.2: Cross-System Call of Functions

For the technical implementation of this advantageously always available, cross-system technical function, the system can use and optionally combine the following alternative user guidance in the sense of a man-machine interface, advantageously with the following features and/or characteristics:

The terminal device (so-called device) or its input and output device (so-called accessory) has touch points with a radius sufficient for interaction at or on the corners of its display in order to call up one of the three function groups mentioned, namely the acquisition, call-up and/or use of data representing contents. Advantageously, the system may use the Fourth Corner for deleting, closing, minimizing, or hiding a displayed content-representing datum or a displayed executable program (app). After calling the function group, the user of the system can use a touch gesture (so-called touch) to select and call a function from the group;

2. the terminal device or its input and output device has touch-sensitive edges on the sides of its display and/or housing, which can each call up one of the three aforementioned function groups, namely the capture, call-up and/or use of data representing content, and their functions. This is especially true for the first two groups of functions namely capturing and/or calling data representing contents. The system can advantageously offer the selection of functions via a swipe gesture (so-called swipe) and/or slide gesture (so-called slide) and trigger it via the interruption of the touch or a subsequent touch gesture (so-called touch). To avoid an unintentional function selection or call, the swipe gesture and/or slide gesture can advantageously be preceded by a single or double touch gesture. Advantageously, when the touch-sensitive edges are on the display, the system can avoid a conflict of the function groups with other functions by having the swipe gesture and/or the sliding gesture start from outside the edge;
3. The terminal or its input and/or output device has touch-sensitive points with a radius or area sufficient for interaction as virtual or physical buttons for calling up the aforementioned function groups, namely capturing, calling up and/or using data representing content. This applies in particular to a virtual or physical keyboard or a comparable control or input device. After calling the function group, the user of the system can advantageously call a function from the group via a touch gesture (touch), via another key or key combination, or via another input device;
4. The terminal device or its input and/or output device advantageously uses a touch-sensitive surface or display that displays two or three horizontal or vertical buttons after a touch gesture or actuation of a key or key combination, the outer buttons opening the call to the first two function groups and the middle button opening a text field for entering content, searches or function calls;
5. The terminal or its input and/or output device uses a keyboard with a touch-sensitive surface (touch pad), which allows the user to call up one of the function groups with a multi-touch gesture, i.e. with several fingers, or with a touch gesture and actuation of a function key, this gesture preferably being a swipe gesture, in order to enable selection of a function in addition to calling up the function groups. This variant is particularly suitable for laptops and stationary personal computers;
and/or
6. The terminal or its input and/or output device uses a touch-sensitive surface or display for swiping gestures from the outer edges of a display to the inner area of the same to call up one of the groups of functions respectively. Analogous to the aforementioned touch-sensitive corner points (cf. item 1.), the system can use a fourth gesture for deleting, closing, minimizing or hiding a date or executable program (app) representing displayed content.

FIGS. 1a, 1b, 1c and 1d, FIG. 10, FIGS. 2a, 2b and 2c and FIG. 3 show exemplary embodiments of the man-machine interface according to the invention using input and output devices of different sizes. FIGS. 1a, 1b, 1c and FIG. 1d show exemplary embodiments of a man-machine interface for devices with a central display area ranging in size from 3 inches to 10 inches diagonally, for example a so-called tablet. The sequence of FIG. 1a and FIG. 1d further shows a sequence of use or a sequence of human-machine interactions. FIGS. 2a, 2b, and c exemplify a human-machine interface for devices with a small display area ranging in size from 1 inch to 3 inches in diagonal, for example, a so-called smart watch. FIG. 3 shows an example of a human-machine interface for devices with a large display area larger than 10 inches diagonally, for example a so-called notebook or laptop.

FIGS. 1a, 1b, 1c and FIG. 1d have the following reference signs:

1 Touch-sensitive activation points on the display for calling up function groups.
2 Touch-sensitive activation surfaces on the display for calling up function groups.
3 Touch-sensitive activation surfaces on the sides of the device for calling up function groups.
4 Superimposed buttons for a three-point menu for calling function groups and intelligent input field
5 Function groups for calling the system-wide basic functions, namely input, processing and/or retrieval of data representing information, of the data processing system.

FIGS. 2a, 2b and 2c show the following reference sign:

6 Touch-sensitive activation surfaces on the sides of the device for calling up function groups from the device itself or from an output unit connected to this device, which can also be another input unit.

FIG. 3 shows the following reference signs:

7 Free-standing or edge-aligned and overlapping function groups for calling the system-wide basic functions, namely input, processing, retrieval, output and/or distribution of data representing information, of the data processing system.
8 Display area for a compilation of data representing individual contents and/or executable programs.
9 Insert buttons for a three-point menu for calling function groups and intelligent input field.

### 1.3 Subsystem S1.3: Cross-System Display of Data Representing Content

After calling one of the system-wide functions, namely input, processing, retrieval, output and/or distribution of data representing information, the system advantageously displays the corresponding man-machine interface (interface) for inputting or capturing (so-called capturing) data representing content, compilations of data representing content, a single data representing content or also a called program (app).

The information and data processing system advantageously has the following features and/or characteristics for displaying and interacting with data and/or programs representing content:

1. exclusive display areas for one or more pieces of content-representative data and/or functions that the system can apply to those pieces of content-representative data, respectively, wherein
a hybrid system with the display of programs, files and folders is enabled,
the system selects and displays functions situationally depending on the type and/or status of displayed data, and/or
the display area for changing information representing data is preferably interactive.
   2. simultaneous, superimposed or juxtaposed display of data representing content, where
the system uses a display in a miniaturized variant, in particular for an overview of many contents, which it does not display statically but dynamically (so-called live panel). This applies in particular to videos or news and message streams (so-called news feeds), and/or
the system can fade in, fade out, fade over, or swap display areas when further data representing content is called up by animations.

Advantageously, the system thus enables technical structures such as programs, files and/or services to be hidden, thus providing greater clarity for the user in particular.

A further embodiment of the invention with respect to subsystem 1 according to the invention provides for a data processing system for ergonomic interaction of a user with data, which has the following features:
at least one processor unit,
At least one local and/or network accessible data store containing data,
local and/or network accessible content representing data objects,
a list of semantic content classes of data objects and the technical criteria of content classes (class list),
a directory of functions available on the system side for an interaction with data and the technical conditions of the functions (function directory),
a human-machine interface for providing information and/or controls with respect to a user's interaction with data,
and

Means or a device for, preferably unmediated provision of situationally appropriate functions (a situational provision of functions) for an interaction of a user with data by means of the man-machine interface with at least two options for action for the user,
a first option with regard to a creation of preferably persistent and/or transient content
and
a second option with regard to a call to data and/or apps representing content,
where
the first option is determined or determinable/derivable using the directory of/containing functions available on the system side for a human-machine interaction with data and the technical conditions of the functions (function directory)
and
the second option is determined or can be determined/derived using the directory of/containing the semantic content classes of the data objects and the technical criteria of the content classes (class directory) and/or using the directory of/containing functions available on the system side for a human-machine interaction with data and the technical conditions of the functions (function directory).

The means/device for the direct provision of functions appropriate to the situation or for the situational provision of functions, advantageously effect/impact in this respect an automatic calculation of dynamic functions for an interaction of a user with data by means of the man-machine interface. In this way, dynamic action options in at least two groups can be used on the system side continuously, i.e. at any time, and displayed or reproduced in particular on the part of an output device, in particular a display device. The calculation is advantageously carried out by means of the processor unit of the system or by means of a computing device of the means/equipment for the immediate provision of functions appropriate to the situation or for the situational provision of functions.

Advantageously, the means/device for the unmediated provision of situationally appropriate functions or for the situational provision of functions, respectively, provide a third option for action for the user with regard to a linking or sharing of content when a data object representing a content is displayed on the system side or is selected by a user, wherein the third option is determined using the directory of/containing content classes and/or content objects available on the system side and/or using the directory of/containing functions for a human-machine interaction and the technical conditions of these functions (function directory) and/or using communication channels available on the system side with regard to a sharing of content with third parties. containing functions available on the system side for a human-machine interaction and the technical conditions of these functions (function directory) and/or using communication channels available on the system side with regard to a sharing of contents with third parties is determined or can be determined/derived.

Advantageously, the means/appliance for providing situationally appropriate functions or for providing functions situationally, provide a fourth option for action for the user with respect to deleting or closing a displayed content and/or app.

In particular, the present invention makes use of the realization that technical structures such as programs and directories or storage locations accessible via directories or web addresses must take a back seat.

According to a further advantageous embodiment of the invention, the system or data processing system further comprises at least one input and/or output device providing a display surface, which at, in and/or on the edge areas of the display surface, preferably and/or optionally at, in and/or on the areas of the corners of the display surface, has in each case a touch-sensitive button for one of at least two, three or also four options for action for the user. In a further advantageous embodiment, the edges of the input and/or output unit are touch-sensitive in order to call up and select the options for action (cf. in particular also FIGS. 1a to 3 and FIG. 6).

For the technical implementation of these ubiquitous or permanent, i.e. at any time available or directly usable, situational options for action, the system according to the invention, which is preferably designed or configured as a terminal device or a terminal device network with an input and/or output device, advantageously makes use of the following configurations, which are in particular provided alternatively:
The terminal or its input and/or output device has touch-sensitive buttons or points, so-called touch points, at or on the corners of its display surface, each of which invokes the options for action for one of the aforementioned core functions, such as capturing, retrieving or using data representing content, or special functions, such as distributing or linking data representing content. Advantageously, the system can use or provide a fourth corner for deleting or closing a displayed content and/or app.
The terminal or its input and/or output device has touch-sensitive edges or touch-sensitive pages on or in the area of the display, each of which invokes the courses of action for one of said core functions, such as capturing, retrieving, or using data representing content.
The terminal or its input and/or output device has, in particular in the area of the display surface, touch-sensitive points, preferably in the form of virtual or physical keys, which each call up the options for action for one of the said core functions, such as the acquisition, retrieval or use of data representing content, or special functions, such as the distribution or linking of data representing content, preferably on a keyboard, for example.

As a technical alternative for fixed menu structures which are bound to programs, the program window or—as in the case of the operating system macOS—the entire display area of a display device, the present invention provides the following means and/or devices for implementing situational user guidance according to the invention, in particular for providing the functions automatically calculated by the system in this respect.

For this purpose, the system or data processing system according to the invention advantageously has in particular the following features and/or properties:
Content display areas, so-called content panels, which can display one or more contents, are used for the output, whereby
advantageously, content editing or usage functions, such as distributing or linking content, are always tied to or with that content,
this binding advantageously applies or takes place both visually for the user guidance and in terms of content for the associated option for action; for example, it makes no sense to play a text, but only video or audio content;. or documents can be shared via email but not via Facebook.
For simultaneous or parallel display or playback of digital content and interaction with digital content, the system can display multiple display areas overlaid or juxtaposed,
whereby, advantageously, the system implements a display in a miniaturized variant, in particular for an overview of many display areas, which advantageously renders the contents not statically but dynamically, so-called live panels, for example a video or a feed.
The display area or display surface of the input and/or output device advantageously replaces program windows and directories or folder structures of today's operating systems,
whereby advantageously hybrid concepts of operating systems are possible, which provide folders, files and programs with program windows and program menus in addition to the dynamic, content-determined display areas provided according to the invention.

Since situational, cross-system user guidance requires a technical alternative to operating systems with fixed menu structures which are bound to programs, the program window or even the entire display area, the output of content display areas (content panels) which can display one or more contents is proposed according to the invention. In this case, functions for editing or use, such as the sharing of content, are always bound with or to this content. This binding applies both visually to the user guidance and in terms of content to the associated option for action. For the simultaneous or parallel display of interactions with digital content, the system according to the invention can display several display areas superimposed or arranged next to each other, whereby the system is used for an overview of many display areas in a miniaturized variant, which does not statically but dynamically reproduce the content (live panel), for example by means of a video or a feed. The display area provided according to the invention replaces program windows and directories or folder structures of today's operating systems, whereby hybrid concepts of operating systems are possible, which know folders, files and programs with program windows and program menus in addition to the dynamic, content-determined display areas.

Further details, features and advantages with regard to a situational provision of content according to the invention arise in particular in connection with the embodiment examples of the invention shown in FIG. 1d and FIG. 3 and explained in more detail below. The display shown schematically in the figures advantageously displays the system according to the invention on a display surface of a screen, in particular displays or monitors, or virtually in space, preferably on the part of the display area of so-called data glasses (smart glasses). A particularly preferred application is thereby given in connection with a device for the virtual output of digital contents, however not as part or extension of reality (augmented reality), but as superimposed contents (blended reality).

2. Subsystem S2: Cross-system, Automatic and Dynamic Compilations of Data, Programs and/or Functions Representing Content.

According to the invention, a system or data processing system is given which advantageously has the following features and/or properties:
Processor unit;
Data storage,
local or accessible via a network;
Data objects representing content,
locally or accessible via a network, and/or
locally or indexed via a network;
Human-Machine Interface,
output of data and/or function options, and/or
Enter data and/or function calls.

This system or subsystem contributes in particular to solving the aforementioned technical problems 2. (Unmediated, direct provision of data, programs and/or functions) and 4. (Overcoming system boundaries of internal and external system boundaries of a terminal device).

Dynamic compilations of content-representative data advantageously offer the user constantly updated overviews according to semantic criteria. At the same time, they advantageously offer fast access to such content-representing data without having to search for it or sequentially use different programs or services that are available locally or via a network.

Advantageously, the aforementioned system according to the invention provides in particular the following embodiments:

1. the user of the system can define dynamic compilations of data and/or programs representing contents, where
the definition is made by the user with or without explicit or implicit linkage to one or more data representing contents, and/or
the system persists the definitions for the dynamic compilations in its data store in order to apply them for calling the compilations.
   2. the user can retrieve from the system dynamic compilations of data and/or programs representing content, whereby
the call is independent or dependent on one or more pieces of content-representing data that the user has explicitly or implicitly selected,
the system executes criteria (so-called constraints) for the selection (selection in the sense of information retrieval) of data representing contents by means of the indices, and/or
the system merges results of selection from different indexes or external systems into a union set.
   3. The system renders the dynamic compilations via an output unit that allows a user to invoke the data objects representing the contents and/or executable programs, where
the system preferably sorts the elements of the compilations according to a rank that it calculates according to temporal, formal, or semantic criteria, or a combination thereof.

According to a further advantageous embodiment, the data processing system according to the invention for the cross-system provision of functions comprises means for the system-side, automatic and dynamic selection of digital contents, whereby means are provided for the retrieval of data representing contents by the user as well as means for the output of data representing contents to the user. This takes into account the fact that modern information technology is characterized by information in distributed storage locations on local terminals, data carriers and on the Internet or in the cloud, and that a large number of programs enable the capture, processing query and output of digital content. Due to this, it is hardly possible for the user to obtain an overview, so that there is a need to search for content or information in different programs or in different locations. According to the invention, this makes it possible to overcome media discontinuities between different programs, between online and offline, and between different data formats, so that access to content and information is provided in terms of content and not in terms of technology. This results in a solution to the technical problem of content selection when obtaining data objects from distributed sources (and not just the purely technical reference), particularly in the case of news streams from social networks and media, where a distinction must be made between important and unimportant content for selection by the user. According to the invention, it can be provided that the user is always offered up-to-date, relevant and personalized content according to semantic criteria through the use of dynamic sets, which also ensure an overview and rapid access to content without the need for a search or sequential query of various programs or services, whether locally on a terminal device or remotely on the Internet or in the cloud. To enable the user to retrieve dynamic sets of data representing content, criteria for the selection (retrieval) of data objects using the indexes are stored in the system. The results of the selection from different indices are merged into a single union set. This union set is output by the system via an output unit with which a user can consume and/or edit the data objects representing content.

3. subsystem S3: cross-system, automatic and adaptive calculation, retrieval and/or provision of data, programs and/or functions representing situational content.

According to the invention, a system or data processing system is given which advantageously has the following features and/or properties:
Processor unit;
Data storage,
local or accessible via a network;
Data objects representing content,
locally or accessible via a network, and/or
locally or indexed via a network;
Human-Machine Interface,
output of data and/or function options, and/or
Enter data and/or function calls.

This system or subsystem contributes in particular to solving the aforementioned technical problems 2. (Unmediated, direct provision of data, programs and/or functions) and 3. (Unmediated, direct processing of data representing content).

Which contents representing data, programs or functions are desired or needed by a person or a user is a very complex question, which can be answered to a large extent only subjectively. However, a system needs deterministic, machine procedures if it wants to or can serve the situation and the need for contents representing data, programs or functions connected with it.

Here, hay risks are advantageously offered, which transfer those complex questions and subjective answers to a simple question and at least sub-subjective and reproducible, calculable answers.

Advantageously, therefore, the system according to the invention provides content-representing data, programs and/or functions that include at least one parameter representing the instantaneous situation or at least one aspect of the situation of the user of a system, or are referenced by the parameter directly or indirectly by means of rules or calculations.

Advantageously, the following embodiments are provided:

### 3.1 Subsystem S3.1: Automatic Representation of a Situation of the User of a System as Parameter of a Data Query

The system acquires the situation of the user in order to be able to offer situational content, programs (apps) and/or functions to the user, wherein the acquisition of the situation for the subsequent retrieval and provision of situational data, programs and/or functions is triggered periodically or by the user by a signal (so-called trigger). For this purpose, the system advantageously uses all or selectively available situational data, preferably location, time, movement, orientation of the terminal device, available and used network, networked input and/or output devices, events, including calendar events, displayed, selected and/or entered texts, and/or incoming sound, image and/or video data.

Advantageously, the system derives classified parameters P1 to Pn from the situational data, which the system optionally selects, combines, optionally expands, and finally uses to query content representing data and/or apps and/or functions for data processing and/or data communication. Classified parameters P1 to Pn are preferably:
location
Time
Activity
Theme
and/or
classified entity (named entity), for example
Person,
Organization, and/or
Product

Activities, the system according to the invention can advantageously derive from the following situational data individually or in combination:
Active or used app,
movement and/or orientation of the end device,
used input and/or output units, and/or
incoming sound, image and/or video data.

In particular, the system can derive classified entities from the following situational data individually or in combination using classified names from an auxiliary data source, machine learning, or heuristics:
Events, especially calendar events,
displayed, selected and/or entered texts,
instantaneous sound, image and/or video data transformed into text, and/or
recognized entities from such sound, image and/or video data.

Topics can advantageously be derived by the system according to the invention in particular from the following situational data individually or in combination by means of extraction of word groups:
Event descriptions, especially calendar events,
displayed, selected and/or entered texts, and/or
internal sound, image and/or video data transformed into text.
   3.2 Subsystem S3.2: Automatic Retrieval of Data, Programs and/or Functions Representing Situational Contents.

The system advantageously translates each of the classified parameters of a situation into individual and/or combined search queries to integrated services available locally or over a network.

Advantageously, depending on the class of a parameter, the system creates a query that determines data objects,
which contain the value of the parameter in arbitrary or selective parts, or
or have at least one property,
which is similar to the parameter, or
is in a value range of the parameter,
and
that belong to one or more classes of content. Classes of content are, for example, people, messages or documents.

The system can advantageously transform parameters into a query that determines data objects, generically or with rules that the system in turn advantageously derives from formalized instructions or machine learning results.

3.3 Subsystem S3.3: Output of Data, Programs and/or Functions Representing Situational Contents

The system evaluates the results of the queries and outputs these results via an output unit, a data storage device or a notification system:
The system can advantageously numerically evaluate the results of the queries as a function of the hits for the classified parameters. The system can advantageously calculate the numerical evaluation as a relative or absolute sum of the hits or the sum of the respective numerical evaluation of the hits, whereby this respective calculation is advantageously performed as a function of the parameter and/or the parameter class that led to the hit.
The results of the queries may advantageously be distinguished by the system, in a complementary or alternative manner, into those representing a classified entity (so-called named entity) corresponding to a parameter and those merely containing the value of a parameter. The former include, for example, a datum representing a person containing the name or email address corresponding to the value of a parameter.
The system can advantageously use the numerical score proportional to the number of hits but also other properties of the content representing data of the results to sort them.
The system may advantageously select the results that contain at least one hit or contain all hits for the parameters representing a situation.
The system can display the results each with dots or similar bullets for each hit, preferably each with a color depending on the parameter class that led to the hit. Consequently, if n parameters (n=integer) have led to a hit in a result, the output unit displays n colored dots for a result. Furthermore, the system can advantageously display information about the parameter that led to the respective hit via a user interaction, for example a touch or an optical overlay of a pointer (so-called mouse or so-called pointer).

### 3.4 Subsystem S3.4: Automatic Optimization of Subsystem 3 Using Machine Learning

Advantageously, the system can offer the user interaction with the results of the queries via the output unit in order to modify and improve those results ad hoc for the current query as well as post hoc for future queries.
The system can advantageously also display the parameters or values of the parameters representing a situation via the output unit. Advantageously, the user can disable, enable and/or add to these elements. Subsequently, the results change depending on whether the system shows the results containing all or at least one hit.
In another advantageous embodiment, the system allows two or three options of selecting those parameters:
   1. The parameter does not have to be contained in the result or correspond to a property of the result;
   2. the parameter must be contained in the result or correspond to a property of the result; and/or
   3. the parameter can be contained in the result or correspond to a property of the result.
The displayed results change advantageously according to the selection made by the user of the system. The system can offer the options, for example, by multiple touching or selecting interactively displayed parameters.

Advantageously, the system uses the option selected by the user in each case for the parameters for a machine learning:

1. For this purpose, the system creates a matrix of parameters P of situations with the following not necessarily exclusive combinations or partial combinations of values:
The activity A of the derived type of a situation,
the selection and/or deselection S of the parameter,
the times of this selection S, and/or
the statistical compression V of that selection S.
   2. the system uses a suitable data structure for the matrix, which it advantageously stores persistently in a data memory (called storage) or non-persistently in a working memory (called memory).
   3. Each selection and/or deselection S of one of the aforementioned options for a parameter advantageously leads to a new or updated entry of the patterns recorded in the matrix, whereby the system for lean data management can advantageously also record the selections S only partially, for example only the deselection of parameters for their consideration in the result set of queries, whereby
the selection S can also be implicit, in that the user of the system does not change the automatically determined parameters for representing the situation,
the system calculates the statistical summarization of the selection S incrementally, ad hoc or in interval, and/or
the computed statistical compression can represent amplification, attenuation, or both trends, for example as opposite functions.

Examples of summarization of selections S are given with the following functions with values of the previously listed parameters:

f(A,M,S)=Σ(Z1 . . . Zn) 1.

f(A,M,S)=Σ(Z1χ1 . . .Znχn) 2.

f(A,M,S)=Σ(Z1χ1 . . . Znχn)/MAX(f) 3.

The second formula advantageously uses an attenuating factor x depending on the time difference between the selection and the present. The third formula features a normalization formula depending on the maximum value of the function f.

The system can advantageously use the machine learning matrix in various ways:
An advantageous embodiment of the system uses the matrix to use, for example disregard, parameters for situations according to their previous selection.
Another advantageous embodiment of the system uses the matrix to calculate a reinforcing and/or weakening factor for the numerical weighting (scoring) of the hits for a situation.

In an alternative embodiment of the invention, the system advantageously uses a multi-dimensional matrix:

1. the system contrasts parameters P1 to Pn (n=integer) in the X dimension of the matrix with the same parameters P1 to Pn (n=integer) in the Y dimension to detect which parameters occur in combination and have been confirmed and/or deselected, where
the intersection points correspond to the selection or deselection S of the corresponding combination of parameters P(x) and P(y),
the selection or deselection S can have a different status, which the system can advantageously represent by a numerical value or Boolean value, and/or
the system can capture multiple sequential selections or deselections S1 to Sm (m=integer) in another dimension.
   2. The system compares in one or more Z dimensions of the combinations of the X and Y dimension further data selectively or in combination, advantageously
activity A or the type of situation derived from activity A,
the selection or deselection S of the parameter P,
the times Z1 to Zn (n=integer) of this selection or deselection S, and/or
the statistical compression V of that selection S.
   3. From the multidimensional matrix, the system can advantageously calculate probabilities and/or execute rules by which it selects and/or weights parameters P1 to Pi (i=integer) for the determination of data representing situational contents in order to calculate a ranking of those determined data representing situational contents, wherein
an advantageous rule can be the selection of the parameters P1 to Pi for the representation of a situation on the basis of the explicit and/or implicit confirmations S or their condensation V of combinations of those parameters in relation to the activity A or the type of situation derived from the activity A, and/or
the system can determine an advantageous probability W of the parameters P1 to Pi of a situation as a relative frequency of the explicit and/or implicit confirmations S or their condensation V of combinations of those parameters in relation to the activity A or the type of situation derived from the activity A.

The following formulas are an example. For the parameter Pi of the parameters P1 to Pn with conditional or unconditional selections S1 to Sm at the times Z1 to Zm, the probability W(Pi) and the relative probability RW(Pi) at the time Z0, where F is a factor:

W(Pi)=Σ(S1(P1)/(e^F×Δ(Z1(P1),Z0)), . . . , Sm(P1)/(e^F×Δ(Zm(P1),Z0)))

RW(Pi)=W(Pi)/MAX(W(P1), . . . W(Pn))

The flowchart shown in FIG. 4 illustrates an embodiment example for the structure of the data processing system and data processing process of subsystem 3 according to the invention, in particular the logical flow for the acquisition of the situational demand and the determination of the suitable data, programs and/or functions representing contents according to subsystem 3.

4. Subsystem S4: Adaptive User Interface for Input and/or Editing of Data Representing Content.

According to the invention, a system or data processing system is given which advantageously has the following features and/or properties:
Processor unit;
Data storage,
local or accessible via a network;
Data objects representing content,
local or accessible via a network,
locally or indexed via a network;
Human-Machine Interface,
output of data and/or function options,
Enter data and/or function calls.

This system or subsystem contributes in particular to solving the aforementioned technical problem 4. (overcoming system boundaries of internal and external system boundaries of a terminal device).

Known human-machine interfaces of data processing systems require the user to select a corresponding program (app) or to select the type of content within such a program when the user wants to create a new data object representing a content.

A system that wants to consistently provide a semantic and non-technical human-machine interface, and thus avoid obvious programs and static menus, must avoid this decision. A new paradigm or concept of adaptive user guidance is required here, in which the system according to the invention advantageously anticipates or recognizes the user's intention and adapts the user guidance and/or the user interface (so-called user interface).

Advantageously, the following embodiments are provided:

### 4.1 Subsystem S4.1: Anticipation of the Intention of a User of the Overall System

Advantageously, the system is able to recognize what the user wants to do and what type of content he wants to capture for it, or what content or type of content he wants to access.

Advantageously, the above-mentioned system is given which is advantageously characterized by the following properties:
The system preferably evaluates a user's text input after each new character is entered to detect the user's intent, wherein
the system recognizes patterns of a character string according to a defined syntax and/or defined grammar; such patterns are, for example, a phrase “To: Max Mustermann” or “Appointment on April 19 at 10 a.m.” or also character strings such as “0”, which indicate a task to be done; other character strings can also merely be associated with a semantic structuring of texts, for example, analogous to the language of Mark Down, characters such as the hash # on a heading; unlike Mark Down, such a control character would not be displayed, but translated into a suitable formatting;
the system matches the recognized pattern with a list of supported intentions or functions; for example, the phrase “To: Max Mustermann” would be associated with the intention of a message, and the phrase “Appointment on April 19 at 10 a.m.” would be associated with the intention of a calendar entry;
the directory has a suitable data structure that allows patterns and intentions or functions to be assigned;
the system interprets the patterns as regular expressions and/or with a vocabulary and/or a grammar; for example, the expression “To: Max Mustermann” can be interpreted with a regular expression for the name-value pair and a vocabulary that takes the name “Max Mustermann” from an address book;
where the system can advantageously use other auxiliary sources for the vocabulary, such as a directory of persons or organizations;
during the text input, by means of said interpretation, the system advantageously makes suggestions for completion; for example, after the recognized intention of a message, the user interface shows a suitable formatting with form fields for addressees and, if necessary, of the subject, as well as a button for sending this message; for example, if the user enters an @ character, the system suggests the most frequently used contacts; if he then enters another word character, it can filter the first or last names of the contacts according to this initial letter;
the system advantageously determines the suggestions of completion from the data and/or auxiliary data sources representing contents accessible to it; and/or
the system advantageously makes new and more precise suggestions after a further input, so that a program loop is created until the system can generate no more suggestions, the user has made a selection or has triggered a function to process the input.

### 4.2 Subsystem S4.2: Adaptive Human-Machine Interface for Anticipated Intention

The user interface automatically adapts to the user's text or image and sound input and changes not only the design, but also the functions and options for machine processing of the input.

Advantageously, the above-mentioned system is provided which is advantageously characterized by the following features and/or properties:
The system advantageously adjusts the user interface and user experience based on the determined mapping; wherein.
the system adapts the layout of a content and the offered options for action and/or functions; for example, after the recognized intention of a message, the user interface displays a suitable formatting with form fields for addressees and possibly of the subject and a button for sending this message; the system can advantageously display the action options analogously to the suggestions for text input exclusively or in combination; for example, if the system has recognized a person by the sequence of an @ sign and name, it can offer, by means of the accessible content representing data and functions, to send the person a text message or email or to start an audio or video call or to display contact details;
the behavior of the system is also stored in a corresponding data structure that refers to the assignment (mapping) of text pattern and interpretation.

The flowchart shown in FIGS. 5a and 5b illustrates an embodiment example for the data processing process of an interpretation of text inputs according to the invention.

A further advantageous embodiment of the invention provides, in particular, for carrying out the functions provided to that extent by the system, the following means and/or devices for automatically processing the creation or editing of digital content. Human-machine interfaces of data processing systems known today require the user to select a corresponding program (for example, a so-called app) or to select the type of content within such a program when the user wants to create a new data object representing a content. The system according to the invention, which aims to consistently provide a semantic and non-technical human-machine interface and thus avoid obvious programs and static menus, advantageously avoids this decision. Accordingly, the invention also provides a new paradigm, a new concept of user guidance, in which the system anticipates or recognizes the intention of the user and advantageously automatically adapts the user guidance and/or the user interface.

Advantageously, the system according to the invention further comprises means/device for anticipating the intention of the user. Advantageously, the system is able to recognize what the user wants to do and what kind of content he wants to capture for this purpose. Advantageously, in particular the following features and/or characteristics are given:

The system evaluates a user's text input to identify their intent, where
the system advantageously recognizes patterns of a string according to a defined syntax and/or defined grammar; such patterns are, for example, a phrase “To: Max Mustermann” or “Appointment on April 19 at 10 a.m.” or also strings such as “0”, which indicate a task to be done; other strings can also be associated merely with a semantic structuring of texts, for example, analogous to the language of Mark Down, characters such as the hash # on a heading. Unlike Mark Down, such a control character would not be displayed, but translated into appropriate formatting;
the system advantageously matches the recognized pattern with a list of supported intentions; for example, the phrase “To: Max Mustermann” would be associated with the intention of a message, and the phrase “Appointment on April 19 at 10 a.m.” would be associated with the intention of a calendar entry;
the directory advantageously has a suitable data structure that enables the assignment of patterns and intentions;
and/or
the system advantageously interprets the patterns as regular expressions and/or with a vocabulary and/or a grammar; for example, the expression “To: Max Mustermann” may be interpreted with a regular expression for the name-value pair and a vocabulary taking the name “Max Mustermann” from an address book; the system advantageously being able to use other auxiliary sources such as a directory of persons or organizations for the vocabulary.

According to a further advantageous embodiment, in the data processing system according to the invention, a man-machine interface is adaptively designed for the creation and editing of digital content by a user, wherein means are provided for evaluating a text input by the user by means of pattern recognition. This addresses the current problem whereby human-machine interfaces of data processing systems require the user to select a corresponding program (app) or the type of content within such a program when the user wishes to create a new data object representing a content. A system that wants to consistently provide a semantic and non-technical human-machine interface, and thus avoid obvious programs and static menus, must avoid this decision, from which a new paradigm, a new concept of user guidance, becomes necessary, in which the system anticipates or recognizes the user's intention and adapts the user guidance and/or the user interface (user interface). The system according to the invention is thus able to recognize what the user wants to do and what kind of content rather wants to create for it, evaluating a text input of the user for this purpose.

Advantageously, means are provided for pattern recognition of a character string according to a defined syntax and/or defined grammar

In a further advantageous embodiment of the data processing system of the invention for situational provision of functions, means are further provided for matching a recognized pattern with a directory of supported intentions.

According to the invention, it is further provided that the directory has a suitable data structure which enables an assignment of patterns and intentions. In this context, patterns are interpreted as regular expressions and/or with a vocabulary and/or a grammar, whereby the system can also use other auxiliary sources such as a directory of persons or organizations for the vocabulary.

Advantageously, the system according to the invention further comprises means/equipment for automatic adaptation of the man-machine interface, so-called adaptive interfaces. Advantageously, the user interface of the man-machine interface automatically adapts to the text or also image and sound inputs of the user and changes not only the design but also functions or options for action. Advantageously, the following features and/or properties are given in particular:

The system adjusts the user interface and user guidance based on the determined mapping, where
the system advantageously adapts the layout of a content and the offered options for action; for example, after the recognized intention of a message, the user interface displays a suitable formatting with form fields for addressees and, if applicable, the subject, as well as a button for sending this message;
and/or
the behavior of the system is advantageously also stored in a corresponding data structure which refers to the mapping of text pattern and interpretation.

In a further advantageous embodiment of the invention, means and/or devices having the following features and/or properties are provided for directly providing functions appropriate to the situation with regard to a user's interaction with data by means of the man-machine interface.

5. Subsystem S5: Interconnection of Terminals for Ergonomic, Adaptive Input and/or Output of Content-Representative Data.

According to the invention, a system or data processing system is given which advantageously has the following features and/or properties:
system with multiple, preferably distributed, terminals that have at least one of the following features and/or characteristics and, in combination, cover the first four characteristics:
one or more, preferably distributed, computing units (in particular CPU and/or GPU)
one or more, preferably distributed, storage units
at least one input unit
preferably at least for physical or virtual keys and/or a gesture control and/or sound or voice input
at least one audio or video (AV) output unit
optionally at least one port, preferably according to USB-C and/or microSD
optionally at least one radio module, preferably according to WAN, LAN or one or more mobile radio networks;
the terminals advantageously have at least one radio module for communication in a local area network for the
Distribution of computing power, and/or
Distribution of memory, preferably for the calculation or storage, including archiving and copies (so-called auto-backup) of data.

This system or subsystem contributes in particular to solving the aforementioned technical problems 3. (Unmediated, direct processing of data representing content), 5. (Resolution of the ergonomic paradox and the previously associated need for multiple terminals), and 6. (Resolution of the dependence on third-party systems as on services available over the network, especially so-called cloud services).

Advantageously, the following embodiments are provided:

### 5.1 Subsystem S5.1: Interconnection of Terminals

The system according to the invention advantageously uses a highly mobile terminal device as the user's personal, central computing unit and data storage device. For the purposes of the present invention, highly mobile means in particular those terminal devices which can be used not only in a mobile manner and not only in a stationary manner, but which can be carried along by the user without a load throughout the day. This includes smartphones and, in particular, portable terminal devices (wearables) such as smart watches, smart glasses, smart clothes and the like. The design of the terminal device is advantageously in the form of a watch or belt buckle. This central computing unit with data storage communicates with an audio-visual input and output unit, as well as further terminal devices for data input and/or control, and extended computing and data capacities.

Advantageously, the above-mentioned system is provided which is advantageously characterized by the following features and/or properties:

1. A highly mobile terminal with
Calculation unit
Data storage unit
Radio module for transmission of
AV signals from and/or to other terminals
Control signals from and/or to other terminal devices
further data to and/or from further end devices
Computing operations from and/or to further end devices
Input unit with
touch-sensitive surface (so-called TouchPad)
Touch-sensitive side edges (so-called TouchBars)
optional visual display
   2. An additional or integrated mobile terminal with
at least one AV input and output unit, preferably with
Video output, preferably as superimposed reality (so-called augmented reality or blended reality)
Audio output, preferably via auditory bone
optional video input via at least one camera
optional audio input via at least one microphone
a control device,
preferably an input with touch-sensitive surfaces, preferably on the side edges of the terminal (so-called TouchBar) or as a so-called virtual keyboard,
a radio module for transmission
of AV signals from and/or to the central terminal device
optional of control signals from and/or to the central terminal device
a preferably optional computing unit for processing the signals
   3. a preferably optional further preferably mobile terminal with
a physical or preferably virtual keyboard
a touch-sensitive surface (TouchPad)
a radio module for transmission
at least of control signals from and/or to further terminals
optional of AV signals from and/or to further terminals
optional of data to and/or from further end devices
optional computing operations from and/or to further end devices
a preferably optional computing unit
to take over computing operations of the central terminal device
a preferably optional connectivity
to other end devices, preferably via USB-C
to storage units, preferably by means of SD and/or microSD
   4. a preferably optional further, preferably stationary terminal device with
a computing unit
for the provision of services
preferably optional for the transfer of expensive computing operations
a radio module for transmission
of control signals from further terminals
of data to and/or from further terminals
for a data communication with a WAN and/or LAN
preferably optional of AV signals from and/or to further terminals
preferably optional of computing operations from and/or to further terminals
a storage unit for
the outsourcing of data from the central end device
for the backup of data from the central terminal.
   5. a preferably optional further, preferably stationary terminal with
at least one AV output unit
for large-area, transparent image and/or video display
for playback of audio signals
a preferably optional AV input unit
a preferably optional computing unit
for the processing of AV signals
for taking over expensive computing operations
a radio module for transmission
at least AV signals from other terminals
preferably optional of AV signals to further terminals
preferably optionally of control signals from and/or to further terminal devices
preferably optional of data to and/or from further terminals
preferably optional of computing operations from and/or to further terminals

Advantageously, the system according to the invention comprises a combination of the following terminal devices:
a watch (smartwatch) as the central computing unit and data storage device,
a pair of glasses (so-called SmartGlasses) for audiovisual input and/or output,
a virtual keyboard (so-called TouchBoard),
a storage and/or communication unit (so-called AirBase) in the sense of a private cloud
and
preferably optional of a large-area transparent display (so-called AirPanel) as a replacement for today's screens

### 5.2 Subsystem S5.2: Distribution of Data

In addition to communication for the exchange of control signals and AV signals, the network of terminals according to the invention as an overall system is advantageously capable of exchanging data and also computing operations.

Advantageously, the above-mentioned system is provided which is advantageously characterized by the following features and/or properties:
The central unit offloads data to another end device in the federation that is not frequently used and/or has an old creation or modification date, where
the system takes care to keep empty memory in an amount relative to the total memory,
the system keeps the information about the existence of the data objects preferably via an index structure,
the system decides which data objects are outsourced according to a ranking and/or the last time the data objects were used or changed.

A formula for ranking can use the parameters time of change, frequency of use, and last use individually or combined, preferably as follows:

float score=sum (1/e^(now−timeStampOfUse*factor))

### 5.3 Subsystem S5.3: Distribution of Arithmetic Operations

Starting from the highly mobile central unit, the network of terminals according to the invention can advantageously share computing operations.

Advantageously, the above-mentioned system is provided which is advantageously characterized by the following features and/or properties:
At least one of the end devices of the federation can take a leading, coordinating role for computing operations, preferably the highly mobile central unit with central data storage, where
expensive computing operations can be outsourced to another terminal A,
computing operations can be transferred directly to another computing unit (preferably processor) or delegated to a service,
the criterion can be the swapping, rendering of images and/or videos, encoding or decoding of files, or the distribution of processes (so-called threads) of a program or the operating system itself.

In this respect, it is further an object of the present invention to provide a system for distributed user guidance and data processing with networked user terminals, comprising one or more distributed computing units, one or more distributed memory units, at least one input unit, at least one output unit, a radio module for communication in a network, wherein an exchange of control signals and output signals between the networked user terminals is provided. Background of the solution: The evolution of mobile terminals is characterized by an increasing discrepancy between lightness and ergonomics. On the one hand, the end devices are getting smaller, lighter and more powerful, on the other hand, the display of content is getting smaller and smaller and the input of data and control commands is getting more and more unwieldy. Lastly, manufacturers are focusing on voice control, which only makes sense for limited use cases such as simple control commands or questions. Last but not least, the tendency can be observed here that the importance of writing is far underestimated in its cultural significance. At the same time, with mobile devices and their operating concepts such as voice control and the availability of data via the cloud, there is a comprehensive loss of privacy. Again, an alternative solution is needed. The system proposed according to the invention for distributed user guidance and data processing with networked user terminals, not only combines mobility and ergonomics, but also enables mobility and data protection and data security.

Advantageously, such a system according to the invention consists of several elements that can communicate with each other in a preferably local, secure radio network. The system advantageously consists, for example, of the combination of a watch (so-called SmartWatch), which serves as a central computing unit and data storage, a pair of glasses (so-called SmartGlasses) for audiovisual input and output, a virtual keyboard (so-called TouchBoard), a storage and communication unit (so-called AirBase) in the sense of a private cloud, and optionally a large-area transparent display (so-called AirPanel) as a replacement for today's screens.

According to the invention, the system uses a highly mobile terminal as the user's personal, central computing unit and data storage device. This can take the form of a watch or a belt buckle, for example, and communicate with other terminals by means of an audiovisual input and output unit for data input and control and for expanding computing and data capacities.

In this respect, the system according to the invention advantageously comprises a highly mobile terminal with a computing unit, a data storage unit, a radio module for transmitting AV signals, control signals, data and computing operations from and to further terminals, an input unit with touch-sensitive surfaces (TouchPad) and touch-sensitive side edges (TouchBars) and an optionally provided visual display. Furthermore, the system comprises an additional or an integrated mobile terminal with at least one AV input and output unit for video output, preferably with superimposed reality (augmented reality or blended reality), for audio output preferably via hearing bones, for optional video input via camera as well as for optional audio input via at least one microphone, an optional control device with touch-sensitive surfaces, preferably on the side edges of the terminal (TouchBar), a radio module for transmitting AV signals as well as control signals from and to the central terminal, and an optional computing unit for processing the signals. Furthermore, the system optionally comprises another preferably mobile terminal with a physical keyboard, preferably a virtual keyboard, a touch-sensitive surface (TouchPad), a radio module for transmitting control signals from and to further terminals and optionally AV signals, data and computing operations from and to further terminals, an optional computing unit for taking over computing operations of the central terminal and an optional connectivity to further terminals (by means of USB-C) and storage units (by means of SD cards). The system according to the invention can also comprise a further, preferably stationary, terminal device with a computing unit for providing services and optionally for taking over expensive computing operations, a radio module for transmitting control signals as well as data to and from further terminal devices, for data communication with WAN and/or LAN, and optionally for transmitting AV signals and computing operations from and to further terminal devices, and a storage unit for swapping out data from the central terminal device as well as for backing up data from the central terminal device. For the system according to the invention, a further, preferably stationary, terminal device can optionally be provided, comprising at least one AV output unit for large-area transparent image and video display and for reproducing audio signals, an optional AV input unit, an optional computing unit for processing AV signals and for performing expensive computing operations, and a radio module for transmitting AV signals from further terminal devices and optionally for transmitting AV signals to further terminal devices, control signals, data and computing operations from and to further terminal devices.

Further details, features and advantages with regard to a highly mobile terminal as a central computing, storage and/or control unit arise in particular in connection with the exemplary embodiment shown in FIG. 7 and explained in more detail below, in this case in the form of a watch with TouchPad and TouchBar.

In addition to communication for the exchange of control signals and AV signals, the interconnection of terminals according to the invention as an overall system is capable of exchanging data, so-called distribution of data.

In addition to communication for exchanging control signals and AV signals, the network of terminals according to the invention as an overall system is also capable of exchanging computing operations, so-called distribution of computing operations. Starting from the highly mobile central unit, the network of terminals can advantageously share computing operations.

In the case of the network of terminals as an overall system according to the invention, the central unit advantageously offloads data to another terminal in the network which is not used frequently and/or has an old creation or modification date, with the system taking care to keep empty memory in an amount relative to the overall memory. Furthermore, the system keeps the information about the existence of the data objects preferably via an index structure and makes the decision which data objects are outsourced according to a ranking and/or the last time the data objects were used or changed.

Starting from the highly mobile central unit, the network of terminals can advantageously share computing operations. According to a preferred embodiment of the system for distributed user guidance and data processing with networked user terminals, one of the networked user terminals assumes a leading or coordinating role for delegating or outsourcing computing operations. This is preferably the highly mobile central unit with central data storage. Expensive computing operations are thereby outsourced to another end device. Computing operations can be transferred directly to another computing unit (processor) or delegated to a service.

According to another useful embodiment of the system according to the invention for distributed user guidance and data processing with networked user terminals, the rendering of images and videos, the encoding or decoding of files or the distribution of processes of a program or an operating system are provided as criteria for delegation or outsourcing of computing operations.

6. Subsystem S6: Interconnection of Terminals for Virtual, Adaptive Input and/or Output of Content-Representing Data.

According to the invention, a system or data processing system is given which advantageously has the following features and/or properties:
A mobile device with
computer unit
Data storage unit
radio module for the transmission of
AV signals from and/or to further terminals
control signals from and/or to further terminals
preferably optional input unit with
touch-sensitive surface (TouchPad)
touch-sensitive side edges (TouchBars)
preferably optional visual display
an additional or integrated mobile terminal with
at least one AV input and/or output unit for
Video output of superimposed reality (augmented reality, blended reality)
Audio output preferably via auditory bone
preferably optional video input via a camera
preferably optional audio input via at least one microphone
preferably optional touch-sensitive side edges (TouchBar)
a radio module for transmission
of AV signals from and/or to the central terminal device
preferably optionally of control signals from and/or to the central terminal device
a preferably optional computing unit for processing the signals

This system or subsystem contributes in particular to the solution of the aforementioned technical problem 5. (resolution of the ergonomic paradox and the previously associated need for multiple terminals).

Advantageously, the following embodiments are provided:

### 6.1 Subsystem S6.1: Virtual Display

The image is preferably output via glasses with a display for digital objects superimposed on reality (augmented reality or blended reality).

Advantageously, the above-mentioned system is provided which is advantageously characterized by the following features and/or properties:
The user sees the digital content superimposed on reality in a freely selectable size and/or positioning in space, for example videos in a large resolution of a cinema screen, texts in a suitable size for editing and notifications in a peripheral view,
where the system can suggest an appropriate size for a content and preferably remember settings of a user of the system for a content type such as video, text or web.
The display is achieved via a coating of the lens and/or an optical projection and redirection or refraction of the image signals, for example via prism, from the lateral frame of the AR glasses.

### 6.2 Subsystem S6.2: Mental Control

The AR display can advantageously be controlled by the touch-sensitive outer sides of the temples of the glasses or by sensors on the inner side of the temples, which advantageously measure brain waves that are evaluated in the glasses or a networked terminal.

Advantageously, the above-mentioned system is provided which is advantageously characterized by the following features and/or properties:
The AR glasses have Brain Control System (BCS) to control the digital display or the digital content displayed, where.

The sensors on the inside of the arms of the AR glasses measure brain waves that are evaluated in a computing unit of the AR glasses or a networked mobile device,
the brain waves control the movement of a pointer (cursor, pointer) in the form of an arrow, point, circle or sphere in three-dimensional Cartesian space, but at least in a two-dimensional space with X and Y coordinates,
the system supports control by allowing interactive elements such as the header of a display area (air panel) and/or buttons to visually change themselves or the pointer, especially if the latter is in the same position,
an additional brain signal, preferably an impulse for the recognition of the intended elements, is used for a selection analogous to a mouse click, for example, to select list elements or other virtual objects.

FIG. 6 shows an exemplary embodiment of the system components of an AR terminal device according to the invention. FIG. 6 shows the following reference signs:

10 The glasses use either a projection of the graphic display in the frame or a foil behind/before/in the lenses for graphic display.
11 The outside of the eyeglass temples are touch-sensitive surfaces for gesture control, especially for, calling up lists and selecting list items.
12 The temples of the glasses contain sensors on the inside for recording brain waves and impulses (Brain Control System).
13 The eyewear temples contain a device on the inside for capturing and outputting audio signals via the auditory bone.
14 Between the lenses, the frame contains a camera on the front for capturing images (photos) and moving images (videos) that the system can use, among other things, to detect objects in the user's field of view.

FIG. 7 shows an exemplary embodiment of the arrangement of virtual objects. FIG. 7 shows the following reference signs:

15. The user's eye behind the lens that can see virtual objects in space.
16. virtual objects that can be arbitrarily scaled and arranged in Cartesian space.

In a further advantageous embodiment of the invention, means and/or devices having the following features and/or properties are provided to enable, in particular, a virtual image output of digital content by means of the man-machine interface. As already explained, the ergonomics and mobility of user terminals are increasingly forming a contradiction. If terminals become smaller and more mobile, the visual display is smaller and smaller and the input elements are smaller and smaller. An obvious example are the latest smartwatches, which can hardly be operated and are suitable for notifications at most. All leading device manufacturers are currently focusing on voice communication with machines. The disadvantage here is that the importance of writing and the need for non-public interaction with machines for the user are not taken into account.

Advantageously, the system according to the invention has means and/or devices that bridge this gap and bring ergonomics and mobility together again. Such a system according to the invention advantageously consists of a combination of a mobile computing unit and virtual display for digital content as networked or integrated terminals.

For the video output of superimposed reality, so-called augmented reality or more precisely blended reality, means or a device are provided on the part of the second or further terminal device, so-called augmented reality display or blended reality display.

The image is preferably output via a pair of glasses whose digital image output is advantageously not immediately recognizable, such as in the first generation of Google Glasses.

In this respect, the object of the present invention is preferably a mobile user terminal comprising a computing unit, a data storage unit, a radio module for transmitting audio/video signals, at least one input unit and at least one output unit, which is characterized in that it can be provided as a man-machine interface of a data processing system for the situational provision of functions. The creation of such a mobile user device is based on the consideration that ergonomics and mobility of user terminals more and more form a contrast. Thus, terminals are becoming smaller and more mobile, from which, however, it also follows that both the visual display and the input elements are becoming smaller and smaller, which can be seen, for example, in the development of so-called smartwatches, which are difficult to operate and are suitable for modifications at best. Leading device manufacturers rely on voice communication with machines, overlooking the importance of writing and the need for non-public interaction with machines. The system according to the invention bridges this gap and brings ergonomics and mobility back together, as such a system consists of a combination of a mobile computing unit and a virtual display for digital content as networked or integrated terminals.

In addition to a computing unit, a data storage unit, a radio module for transmitting AV signals from and to other terminals and control signals from and to other terminals, the mobile terminal according to the invention optionally comprises an input unit with a touch-sensitive surface (TouchPad) and touch-sensitive side edges (TouchBars) and an optional visual display. Furthermore, it can be provided that the terminal device has an AV input and output unit for video output of superimposed reality (augmented reality or blended reality) as well as for audio output preferably via hearing bones. Furthermore, audio input may be provided via at least one microphone.

Another advantageous embodiment of the invention provides means or a device for enabling mental control by the user.

Advantageously, the AR display is controllable by the user through touch-sensitive outer sides of the temples of the glasses or through sensors on the inner side of the temples of the glasses. Advantageously, the touch-sensitive outer sides of the temples of the glasses or the sensors on the inner side of the temples of the glasses measure brain waves of the user. The measured brain waves of the user are then evaluated by a computing device in the glasses or by a computing device in a networked terminal and converted into control signals.

Further details, features and advantages of AR glasses according to the invention arise in particular in connection with the embodiment example shown in FIG. 6 and FIG. 7.

### BRIEF DESCRIPTION OF THE DRAWINGS

Further details, features and advantages of the invention are explained in more detail below with reference to the embodiments shown in the figures of the drawings. Thereby showing:

FIG. 1a is an example of a terminal device with a central display area;

FIG. 1b is a side view on the left according to FIG. 1a;

FIG. 1c is a right side view according to FIG. 1a;

FIG. 1d is a further illustration of the embodiment according to FIG. 1a;

FIG. 2a is an example of a terminal device with a small display area;

FIG. 2b is a left side view according to FIG. 2a;

FIG. 2c is a side view according to FIG. 2a;

FIG. 3 is an example of a terminal device with a large display area;

FIG. 4 is a flow chart of an embodiment of the structure and data processing process of a data processing system according to the invention;

FIGS. 5a and 5b are flowcharts of an embodiment example of a data processing process of an interpretation of text inputs according to the invention;

FIG. 6 is an embodiment of AR glasses; and

FIG. 7 is an example of an AR glasses application.

### DETAILED DESCRIPTION

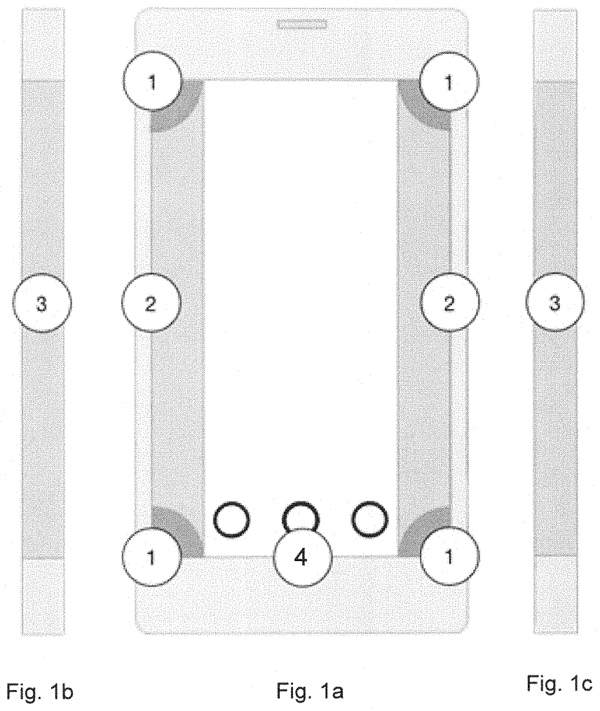

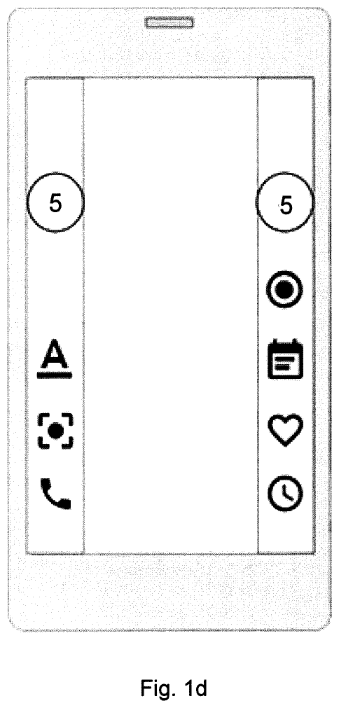

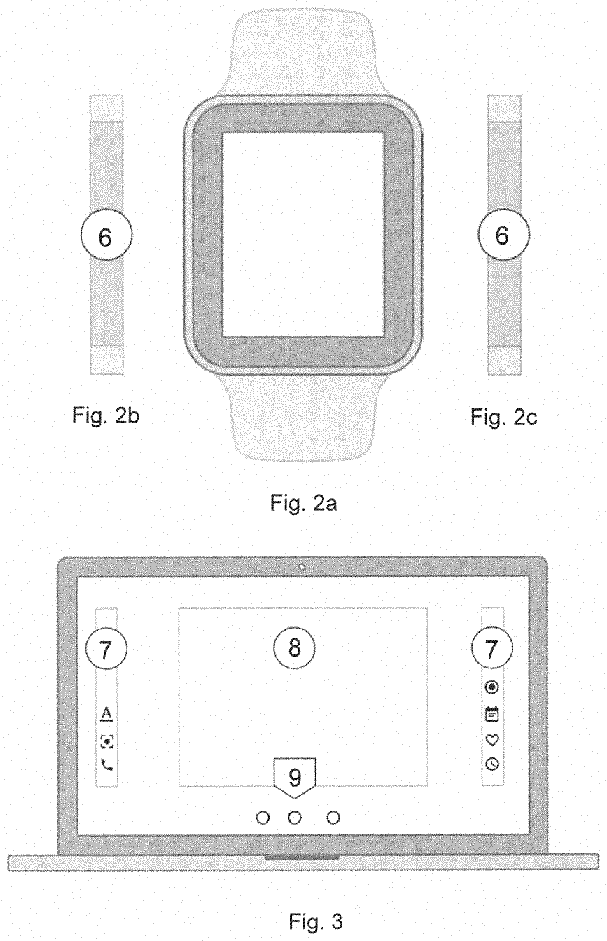

FIGS. 1a, 1b, 1c and 1d, FIGS. 2a, 2b and 2c, and FIG. 3 show exemplary embodiments of the man-machine interface according to the invention using input and output devices of different sizes. FIG. 1a and FIG. 1d show exemplary embodiments of a man-machine interface for devices with an average display area of 3 inches to 10 inches diagonally, for example a so-called tablet. The sequence of FIG. 1a and FIG. 1d further shows a sequence of use or a sequence of human-machine interactions. FIG. 2a shows an exemplary human-machine interface for devices with a small display area of 1 inch to 3 inches diagonal, for example a so-called smart watch. FIG. 3 shows an example of a human-machine interface for devices with a large display area of more than 10 inches diagonally, for example a so-called notebook or laptop.

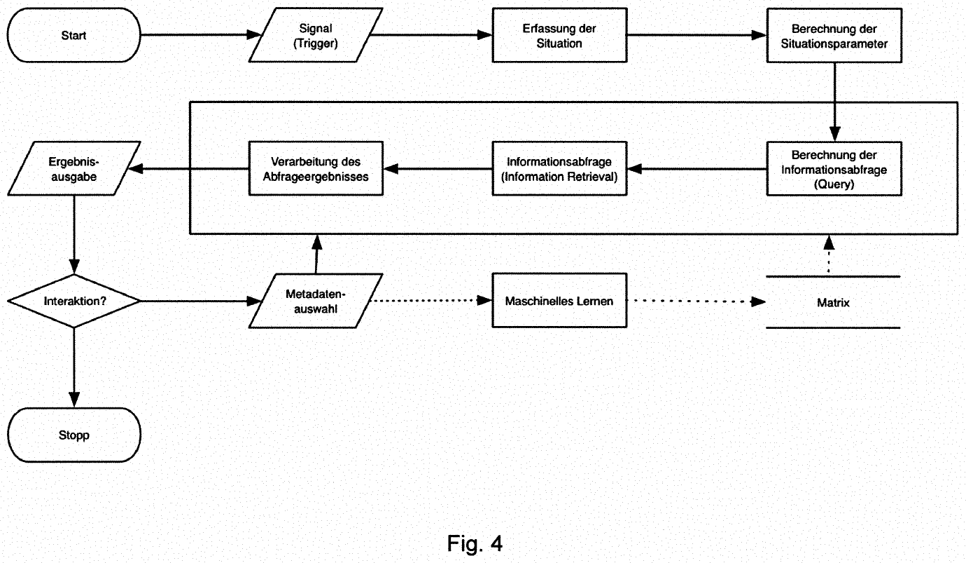

The flowchart shown in FIG. 4 illustrates an embodiment example of the logical flow for the acquisition of the situational demand and the determination of the appropriate content representing data, programs and/or functions.

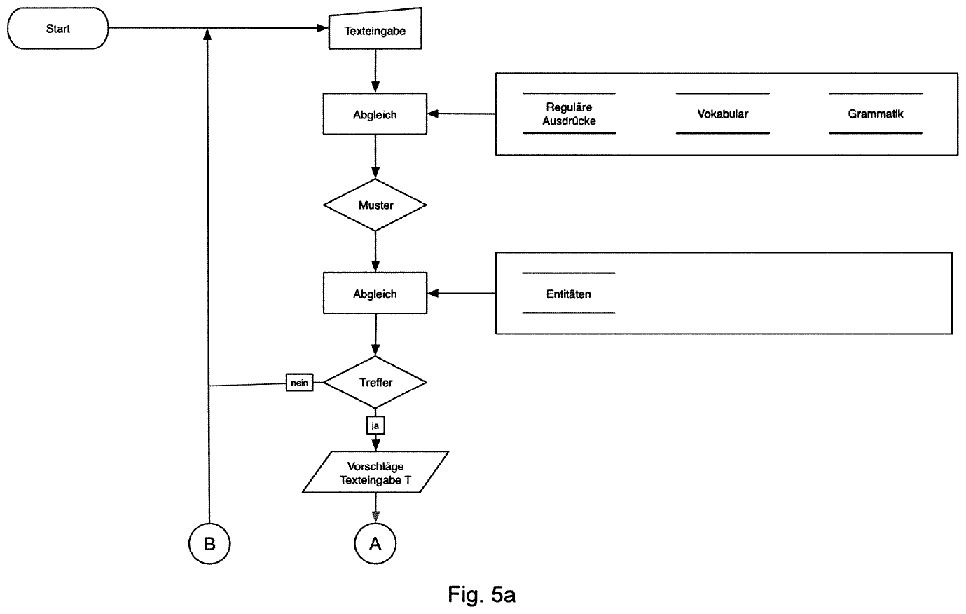

The flowchart shown in FIGS. 5a and 5b illustrates an embodiment example for the data processing process of an interpretation of text inputs according to the invention.

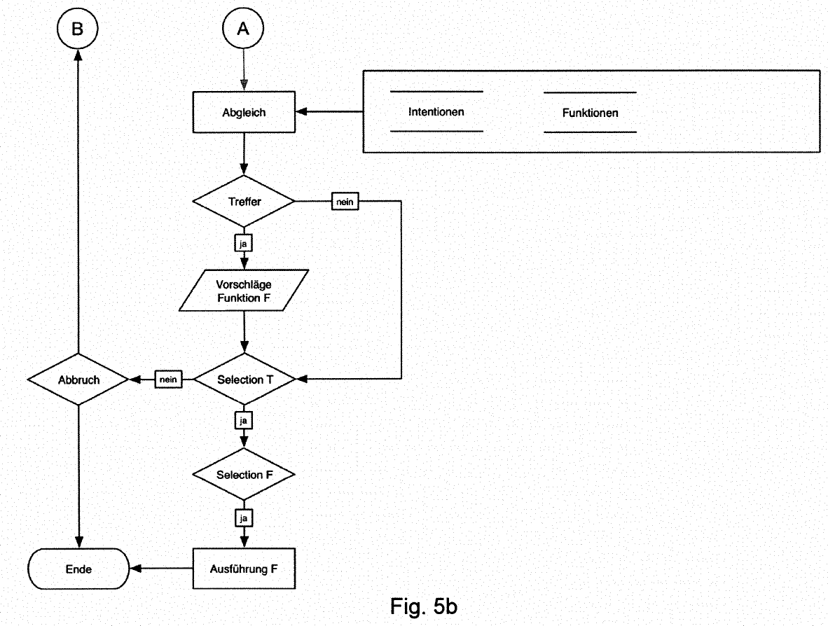

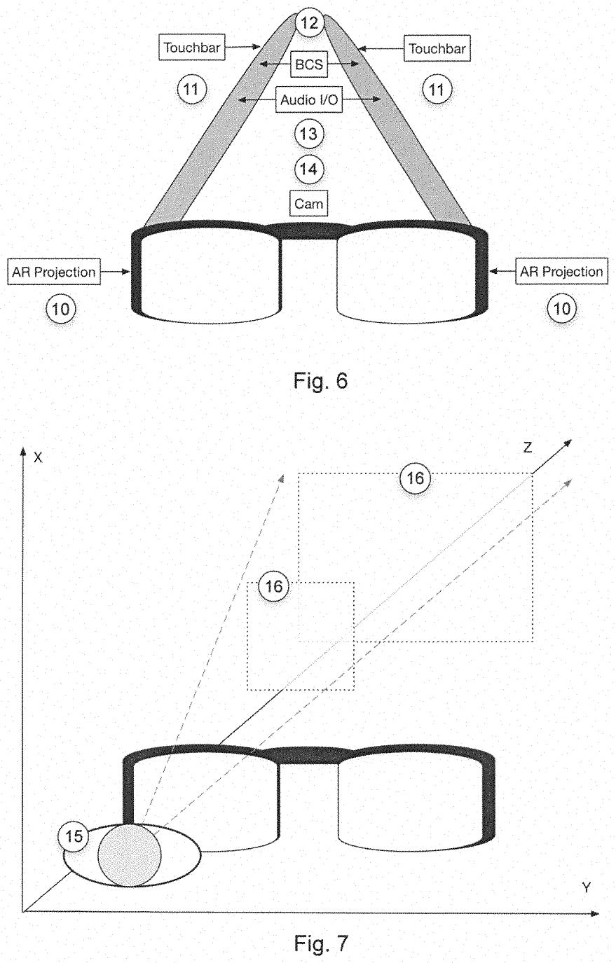

FIG. 6 and FIG. 7 show an example of a system for virtual image output of digital content. Thereby, FIG. 6 shows an embodiment example of AR glasses, which either contain a projection of a graphic display in the frame or a foil for graphic display behind or in front of or in the glasses 10. On the outside, the glasses temples 11 are provided with touch-sensitive surfaces for gesture control, in particular for calling up lists and selecting list items. On the inside, however, the eyeglass temples 11 include sensors 12 for sensing brain waves and impulses (brain control system). The sensors on the inside of the temples of the AR glasses measure brain waves, which are evaluated in a computing unit of the AR glasses or in a networked mobile terminal. The brain waves can thereby control the movement of a pointer in the form of an arrow, point, circle or sphere in three-dimensional Cartesian space, but at least in a two-dimensional space with X and Y coordinates. On the system side, control is supported by interactive elements such as the header of a display area (air panel) or the buttons optically changing themselves or the pointer if the latter is at the same position. Another brain signal, preferably an impulse for recognizing the intended elements, is used for a selection analogous to a mouse click. Furthermore, the eyeglass temples 11 contain a device 13 on the inner side for detecting and outputting audio signals via the auditory bone. Between the eyeglass temples, the frame includes a camera 14 on the front side for capturing images (photos) and moving images (videos), which the system can use, among other things, to recognize objects in the user's field of view.

FIG. 7 shows an embodiment example for the application of AR glasses, in which the eye 15 of the user can see virtual objects in space behind the lens of the glasses. These virtual objects 16 are arbitrarily escalated in the pathetic space and can be arbitrarily arranged in it.

The embodiments shown in the figures of the drawing and the embodiments explained in connection therewith serve only to explain the invention and are not limiting.

### LIST OF REFERENCE SIGNS

1 Touch-sensitive activation points on the display for calling up function groups
2 Touch-sensitive activation surfaces on the display for calling up function groups
3 Touch-sensitive activation surfaces on the sides of the device for calling up function groups
4 Function groups for calling the system-wide basic functions, namely input, processing, retrieval, display and/or distribution of data representing information, of the data processing system.
5 Superimposed buttons for a three-point menu for calling function groups and intelligent input field
6 Touch-sensitive activation surfaces on the sides of the device for calling up function groups from the device itself or from an output unit connected to this device, which can also be another input unit.
7 Free-standing or edge-aligned and overlapping function groups for calling the system-wide basic functions, namely input, processing, retrieval, display and/or distribution of data representing information, of the data processing system.
8 Display area for a compilation of individual content representing data and/or executable programs.
9 Superimposed buttons for a three-point menu for calling function groups and intelligent input field
10 AR projection
11 Glasses temple with touchbar
12 Sensors for the detection of brain waves and impulses
13 Device for the acquisition/output of audio signals via the auditory bone
14 Camera for taking photos/videos
15 User eye
16 Virtual objects
A Activity
S Selection or deselection
T Text
Z Time
AR Augmented reality display or blended reality display
AV Audio and/or video

What is claimed is:

1-21. (canceled)

22. A data processing system for ergonomic interaction of a user with data, comprising:
at least one processor unit;
at least one local and/or network accessible data store containing data;
local and/or network accessible content representing data objects;
a list of semantic content classes of data objects and the technical criteria of content classes;
a list of/containing functions available on the system for an interaction with data and the technical conditions of the functions; and
a human-machine interface for providing information and/or controls with respect to a user's interaction with data, comprising:
providing continuously directly cross-system functions for a user's interaction with data by the man-machine interface with at least two options for action for the user;
a first option with regard to a capture of persistent and/or transient content; and
a second option with regard to a call to data and/or apps representing content, wherein:
the first option is determined or can be determined using the list of functions available on the system for a human-machine interaction with data and the technical conditions of the functions; and
the second option is determined or determinable using the list of semantic content classes of the data objects and the technical criteria of the content classes and/or using the list of/containing system-side available functions for a human-machine interaction with data and the technical conditions of the functions.

23. The data processing system according to claim 22, comprising a third option for action for the user with regard to linking or sharing content with third parties via communication channels when a data object representing a content is displayed on the system side or selected by a user, wherein the third option is determined or determinable using the directory of content classes and/or content objects available on the system side and/or using the directory of functions available on the system side for a human-machine interaction with data and the technical conditions of the functions.

24. The data processing system according to claim 23, further comprising a directory of communication channels available on the system side with regard to sharing of contents of the user with third users or systems.

25. The data processing system according to claim 22, comprising a fourth option for action for the user with regard to deleting or closing a displayed content.

26. The data processing system according to claim 22, comprising at least one input and/or output device providing a display surface, which has at, in and/or on the edge areas of the display surface and/or the terminal at in and/or on the areas of the corners of the display surface, in each case a touch-sensitive button for one of at least two options for action for the user.

27. The data processing system according to claim 22, wherein content-representing data, programs and/or functions which contain at least one parameter representing the current situation or at least one aspect of the situation of the user of the data processing system or are referenced by this parameter directly or indirectly by rules or calculations, being determined by the detection of location, time, movement, orientation of the terminal, available and/or used network, networked input and/or output devices, events, in particular calendar events, active and/or used application programs (apps), displayed, selected and/or entered texts, and/or incoming sound, image and/or video data.

28. The data processing system according to claim 22, wherein the man-machine interface is designed adaptively for the creation or processing of digital content by the user being provided for evaluating a text input by the user by pattern recognition in such a way that adaptive user guidance is provided, in which the system according to the invention anticipates or recognizes the intention of the user and adapts the user guidance and/or the user interface.

29. The data processing system according to claim 28, wherein means are provided for pattern recognition of a character string according to a defined syntax and/or defined grammar.

30. The data processing system according to claim 28, wherein means are provided for matching a recognized pattern with a list of supported intentions.

31. The data processing system according to claim 30, wherein the directory has a suitable data structure which enables an assignment of patterns and/or intentions, preferably the patterns being interpreted as regular expressions and/or with a vocabulary and/or a grammar, preferably the vocabulary also matching other auxiliary sources, in particular a directory of persons and/or organizations.

32. The data processing system according to claim 22, wherein:
the user of the system can define dynamic compilations of data and/or programs representing contents, wherein:
the definition by the user is done with or without explicit or implicit linkage to one or more data representing contents; and/or
the system persists the definitions for the dynamic compositions in its data store in order to apply them for the invocation of the compositions;
the user can retrieve from the system dynamic compilations of data and/or programs representing content, wherein:
the call is independent of or dependent on one or more data representing contents which the user has explicitly or implicitly selected;
the system executes criteria (constraints) for the selection of data representing content using indexes; and/or
the system combines results of the selection from different indices or external systems to a union set; and/or
the system renders the dynamic compilations via an output unit with which a user can call up the data objects representing contents and/or executable programs, the system sorting the elements of the compilations according to a rank which it calculates according to temporal, formal or semantic criteria or a combination thereof.

33. The data processing system according to claim 32, wherein the output of data representing contents to the user is performed by dynamic sets which continuously offer or reproduce current contents according to defined criteria.

34. The data processing system according to claim 22, comprising content representation areas on the part of a display device, which are provided for the output and/or retrieval of data representing contents and represent or reproduce one or more contents in a subordinate or secondary manner.

35. The data processing system according to claim 22, for ergonomic interaction of a user with data, by means of distributed user guidance and data processing with networked user terminals, comprising:
one or more distributed computing units;
one or more distributed storage units;
at least one input unit;
at least one output unit; and
a radio module for communication in a network, wherein means are provided for exchanging control signals and/or output signals between the networked user terminals.

36. The data processing system according to claim 35, wherein a leading or coordinating role for delegating or outsourcing computing operations is provided for one of the networked user terminals.

37. The data processing system according to claim 35, wherein the criteria for delegation or outsourcing of computing operations are rendering of images and videos, encoding or decoding of files, or distribution of processes of a program or an operating system.

38. The data processing system according to 35, wherein the user terminal is provided as a man-machine interface of the data processing system.

39. The data processing system according to claim 22, wherein the display takes place on a display surface of a screen or virtually in space, on the part of the display area of data glasses (smart glasses), in connection with a device for the virtual output of digital content, but in this case not as part of or an extension of reality (augmented reality), but as superimposed content (blended reality).

40. A mobile user terminal, comprising:
a unit of computation;
a data storage unit;
a radio module for the transmission of audio/video signals;
at least one input unit; and
at least one output unit, wherein the mobile user terminal is provided as a man-machine interface of the data processing system and is a user terminal of the data processing system according to claim 35.

41. A user terminal according to claim 40, wherein, in addition to a computing unit, a data storage unit, a radio module for transmitting AV signals from and to further terminals and control signals from and to further terminals, this comprises an input unit with a touch-sensitive surface (TouchPad) and touch-sensitive side edges (TouchBars) and an optional visual display, wherein it is provided that the user terminal is connected or connectable to an audio and/or video input and output unit for video output of superimposed reality (blended reality) and for audio output, via hearing bones connectable.

42. The user terminal according to claim 41, wherein the reproduction or display of a superimposed reality (blended reality) takes place by a transparent display or projection and can be controlled by the user by touch-sensitive outer sides of the temples of the data glasses or by means of sensors on the inner side of the temples of the data glasses, the touch-sensitive outer sides of the temples of the data glasses or the sensors on the inner side of the temples of the data glasses preferably measuring or being able to measure brain waves of the user, and the measured brain waves of the user being evaluated by a computing device in the data glasses or by a computing device in a networked terminal and being converted or being able to be converted into control signals. and the measured brain waves of the user are evaluated by a computing device in the data glasses or by a computing device in a networked terminal and are converted or can be converted into control signals.
